(19) United States
(12) Patent Application Publication
(10) Pub. No.: US 2015/0160671 A1
(43) Pub. Date: Jun. 11, 2015

(54) POWER SUPPLY FOR VARIABLE SPEED BLOWING DEVICES WITH ELECTRICAL ENERGY MANAGEMENT

(71) Applicant: INDUSTRIAL TECHNOLOGY RESEARCH INSTITUTE, HSIN-CHU (TW)

(72) Inventors: YANG-GUANG LIU, Hsinchu (TW); LIANG-CHIAO HUANG, Changhua County (TW); MIN-JU LIN, New Taipei (TW); MENG-YEN TSAI, HSINCHU (TW); WEI-DA TU, HSIN-CHU (TW); YU-CHOUNG CHANG, Hsinchu County (TW)

(21) Appl. No.: 14/465,618

(22) Filed: Aug. 21, 2014

(30) Foreign Application Priority Data
Dec. 11, 2013 (TW) 102145679

(51) Int. Cl. G05F 1/66

(52) U.S. Cl. CPC G05F 1/66

(57) ABSTRACT

A power supply with electrical energy management, applied to variable speed blowing devices includes a rectification unit with a power factor correction function, a DC voltage stabilizing unit, a control unit, an input unit, a communication unit, at least one DC voltage regulator unit with an electrical energy measuring function, and at least one variable speed blowing devices. The rectification unit and the DC voltage stabilizing unit can use AC and DC as the power sources, respectively. The control unit utilizes the input information of the input unit and the electrical energy measuring information of the at least one DC voltage regulator unit to adjusts the output terminal voltages of the at least one DC output voltage regulator unit via applying a priority method, so that the load-shedding operation of the variable speed blowing device can be performed to meet the optimal regional demand control.

### CROSS REFERENCE TO RELATED APPLICATION

The present application is based on, and claims priority from, Taiwan Application Serial Number 102145679, filed on Dec. 11, 2013, the disclosure of which is hereby incorporated by reference herein in its entirety.

### TECHNICAL FIELD

The present disclosure relates to a power supply and a control method for electrical energy management, and more particularly to the power supply and the corresponding electrical energy reservation method for variable speed blowing devices in which the regional demand control can achieved by evaluating criteria for the optimal regional demand.

### BACKGROUND

The power supply and the control framework of conventional variable speed blowing devices shown in FIG. 1. When the blowing devices undergo a flow control to adjust the temperature according to a preset temperature, the central control system issues automatically speed commands of the blowing devices to all the control units of individual regional blowing devices, or speed commands are manually inputted to the control unit (for example, through the control panel to select a flow volume around strong, middle, and weak positions) such that the frequency-varying unit can adjusts the speed of the blowing device and the flow volume.

Currently, in majority of the conventional frequency-varying units, after the AC is transformed into a corresponding DC voltage by a power factor correction, a pulse width modulation (PWM) is performed to control the motor speed of the blowing device according to the speed commands. However, the conventional variable speed blowing devices under an electrical energy management control have at least the following shortcomings.

As shown, the renewable electrical energy source device is parallel coupled to the AC network via the current-varying and transforming unit, and thus does not directly provide power to the existing loads.

In the art, each blowing device or each appliance needs an accompanying AC power meter for measuring, and data of the power meter is forwarded to the electrical energy management system to generate a corresponding load command of the blowing device. The load command is then sent to the blowing devices for a control purpose by the communication unit. However, the total application cost is thus expensive due to the cost of installing the power meter, the usage of the communicative software and hardware, and the number of the blowing devices.

While in introducing the electrical energy management system to perform the demand control upon the blowing devices, if the total accumulative power consumption of the blowing devices exceeds the upper limit of the preset demand, a predetermined scheduling command for a regional priority load shedding, a circulating load shedding and so on would be generate and sent to the control unit of the corresponding blowing device via the communication unit. Thereafter, a speed reducing command would be performed to adjust the speed of the blowing device so as to reduce the load. Generally, the scheduling control command of the conventional variable speed blowing devices is less flexible and thus is opt to damage the original electrical energy management system even the preset speed command of the blowing device for the regional environmental conditions is obeyed. If the electrical energy management system fails, abnormal temperature changes such as over heat or over cool would happen to some regional environmental temperatures. Then, the total air-conditioning environment would present less comfort. Namely, the purpose of the demand control mechanism is not achieved.

### SUMMARY

The present disclosure aims at the cost hike in power supply for a current power system, especially while in meeting an enlarged difference between the in-peak load and the off-peak load, by which the cost for providing power would be greatly increased by a huge investment paid for ensuring the power supply during the in-peak period. To ensure the power supply during the in-peak period, a big money will be invested to purchase sufficient facilities so as to afford the power demand during the short-term in-peak period. However, such a facility investment would seem to be redundant and thus uneconomic for the power demand in the off-peak period. Therefore, a power demand management upon the power system for reducing the cost of power supply anytime, increasing the facilities usage rate, and lowering the possibility of power shortage is definite important. Namely, by introducing the power demand management to the power system or power factory for efficiently controlling the electric load, the cost for power supply can be lowered, the shortage in power supply can be avoided, the fee for electricity to the consumers can be lowered, the usage rate of the facilities can be increased, the redundant power capacity during the off-peak period can be minimized, and the environmental pollution can be controlled.

In order to improve the demand control on the aforesaid conventional blowing devices, in which the AC power of the municipal power network is rectified by a power factor correction firstly so as to provide a constant terminal voltage to all the variable speed blowing devices and further the communication interface issues a speed command to proceed the speed control, a power supply for variable speed blowing devices is provided in this disclosure to integrate the DC/AC transformation and to dynamically vary terminal voltages. Also, an accompanying electrical energy management control method is provided to meet an optimal scheme for the maximum demand control.

The power supply and the electrical energy management method of this disclosure are applicable to the electrical energy-reserved control for variable speed blowing devices, in which the power supply include a rectification unit for performing the power factor correction, a DC voltage stabilizing unit, a control unit, an input unit, a communication unit, at least one DC voltage regulator unit with an electrical energy measuring function, and at least one set of variable speed blowing devices. The rectification unit and the DC voltage stabilizing unit of the power supply are energized by the municipal AC power network and a DC power source, respectively. The power supply can also have the renewable electrical energy source to supply power to the load via the DC voltage stabilizing unit. Namely, in this disclosure, both the rectification unit and the DC voltage stabilizing unit can be the power sources. The control unit utilizes input information of the input unit and the electrical energy measuring information of the at least one DC voltage regulator unit and further introduces the priority method to adjust the terminal voltages outputted from the at least one DC voltage regulator unit, such that the speeds of individual variable speed blowing devices can thus be controlled.

The control unit utilizes input information of the input unit and the electrical energy measuring information of the at least one DC voltage regulator unit and further introduces the priority method to adjust the terminal voltages outputted from the at least one DC voltage regulator unit, such that load shedding to the variable speed blowing devices can be performed so as to achieve the regional demand control.

The control unit can use the communication unit to output the electrical energy measuring information to a far-end electrical energy management system. Further, according to the optimal computation algorithms for system's electrical energy reservation, the optimal power consumption preset value of the blowing devices can be obtained. The optimal power consumption preset value of the blowing devices is then sent back to the control unit of the power supply so as to adjust the corresponding terminal voltages of the at least one DC voltage regulator unit. Then, the speed of the blowing device can be adjusted, and the optimal electrical energy-reserved control can be achieved. Hence, the power supply of this disclosure has functions at least in adjusting terminal voltages and in measuring the power consumption.

The electrical energy management method in this disclosure includes a step of the control unit accessing the preset demand's upper bound of the input unit, the priority information and the electrical energy measuring information of the at least one DC voltage regulator unit, and a step of the control unit introducing a modified priority computation method to calculate the modified power consumption preset value of the at least one DC voltage regulator unit. The foregoing computation method includes a step of the input unit giving priorities a1, a2, . . . , an for the at least one DC voltage regulator unit and the power demand's upper bound Pupp; a step of the control unit accessing the power consumption measuring information P1, P2, . . . , Pn and the total power consumption Psum (Psum=P1+P2+ . . . +Pn) of the at least one DC voltage regulator unit; a step of the control unit calculating the modified priorities b1, b2, . . . , bn and the sum of the modified priorities bsum (bsum=b1+b2+ . . . +bn),

$$b 1 = a 1 \times ( \frac{P 1}{Psum} ) , b 2 = a 2 \times ( \frac{P 2}{Psum} ) , … , bn = an \times ( \frac{Pn}{Psum} ) ;$$

a step of the control unit calculating the modified power consumption preset values P1′ to Pn′ of the at least one DC voltage regulator unit,

$$P {1}^{′} = P 1 - ( \frac{b 1}{bsum} ) \times ( Psum - Pupp ) , … , \\ {Pn}^{′} = Pn - ( \frac{bn}{bsum} ) \times ( Psum - Pupp )$$

and

a step of sending the modified power consumption preset values back to the control unit of the power supply. In the computation, the control unit judges the relation of the speed and the power consumption to transform the power consumption preset values into the corresponding DC terminal voltages between the at least one DC voltage regulator unit and the corresponding motors of the blowing devices. The at least one DC voltage regulator unit is also controlled to output the DC terminal voltages to the corresponding drive units of the respective variable speed blowing devices so as to adjust the speeds of the corresponding motors of the blowing devices. Upon such an arrangement, the variable speed blowing devices can be operated to meet the power demand control.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic control framework of a conventional frequency-varying blowing devices;

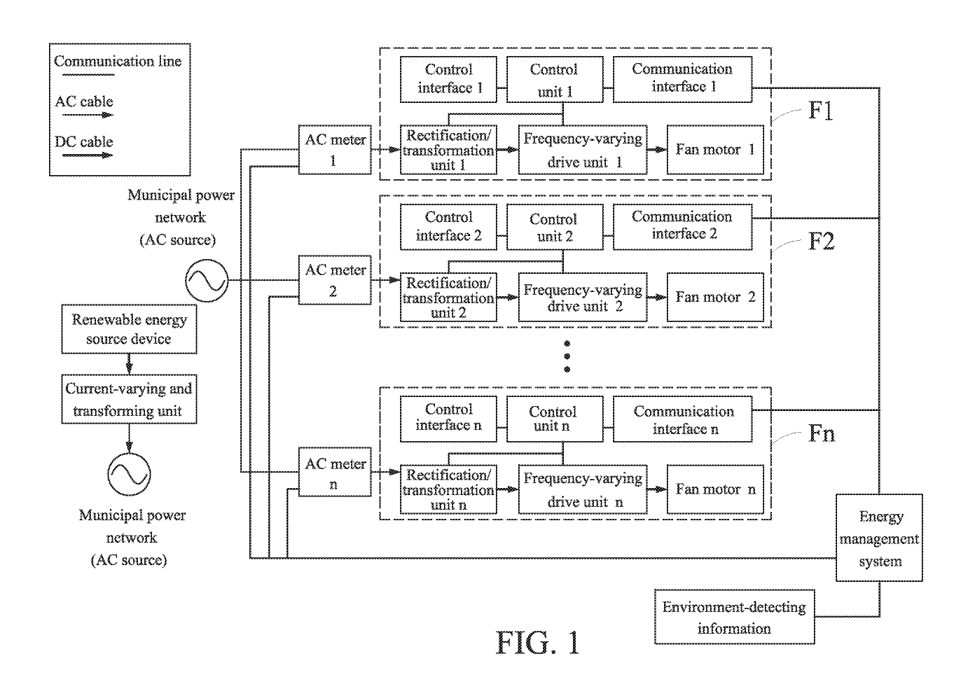

FIG. 2 is a schematic control framework of one embodiment of the power supply for variable speed blowing devices in this disclosure;

FIG. 3 is a flowchart of an embodiment of a regional demand control of the electrical energy management method in this disclosure;

FIG. 4 shows operational characteristics between the terminal voltages of blowing devices and the corresponding speeds of the blowing devices in this disclosure; and

FIG. 5 is a flowchart of an embodiment of a far-end demand control of the electrical energy management method in this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

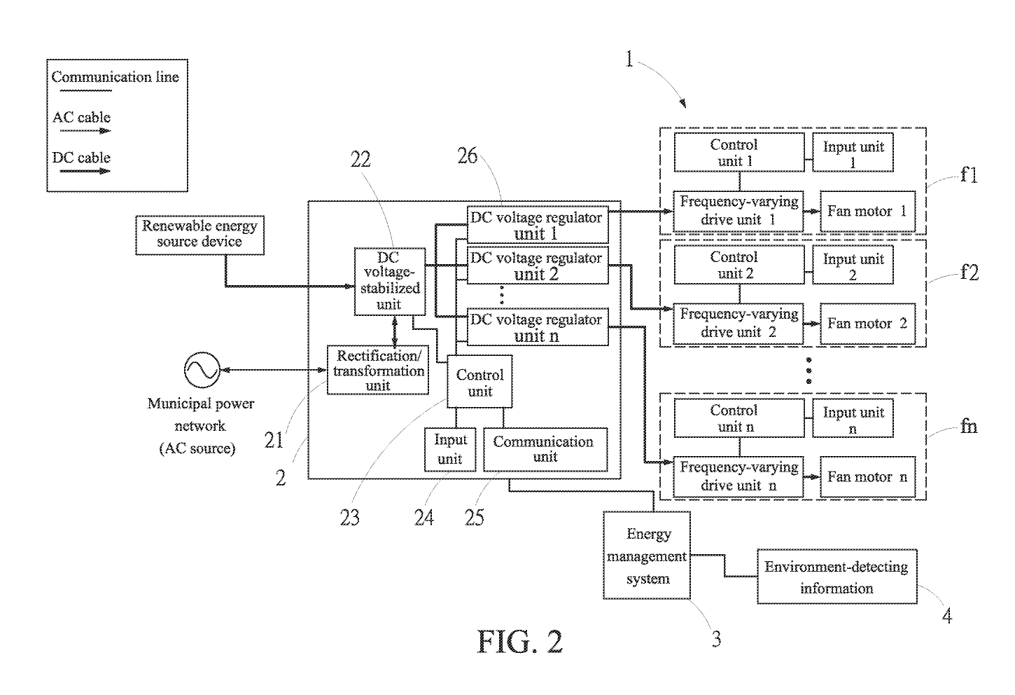

Referring now to FIG. 2, a control framework of an embodiment of the variable speed blowing devices 1 for the power supply 2 is shown. The control framework includes at least one blowing device 1 (n shown in FIG. 2), a power supply 2, an electrical energy management system 3, and an environment-detecting information system 4. The power supply 2 includes a rectification unit 21 with a power factor correction function, a DC voltage stabilizing unit 22, a control unit 23, an input unit 24, a communication unit 25, at least one DC voltage regulator unit 26 (n shown in FIG. 2) with an electrical energy measuring function. The rectification unit 21 is electrically connected with a foreign AC power of the municipal power network and the DC voltage stabilizing unit 22. The DC voltage stabilizing unit 22 is electrically connected with the rectification unit 21, a foreign renewable energy source, and each of the DC voltage regulator units 26. The control unit 23 is signally connected with the DC voltage stabilizing unit 22, the input unit 24, the communication unit 25, and each of the DC voltage regulator units 26. The input unit 24 is signally connected with the control unit 23. The communication unit 25 is signally connected with the control unit 23. The DC voltage regulator units 26, arranged electrically and signally parallel to each, are electrically connected with the DC voltage stabilizing unit 22 and signally connected with the control unit 23. Each of the DC voltage regulator units 26 is paired to a respective one of the blowing devices 1 and thus to energize the corresponding blowing device 1. Each of the flowing devices 1 further includes a control unit, an input unit, a frequency-varying drive unit and a motor. In addition, as shown in FIG. 2, the electrical energy management system 3 is signally connected with the environment-detecting information system 4 and the power supply 2, while the environment-detecting information system 4 is signally connected with the electrical energy management system 3.

The rectification unit 21 of the power supply 2 can be energized by the AC to perform the power factor correction so as to become a candidate of the DC source. The DC voltage stabilizing unit 22 can be energized by the DC to perform the voltage transformation so as to become another candidate of the DC source. The DC source is coupled with the DC voltage stabilizing unit 22 so as to supply power as a power source, or the renewable electrical energy source is coupled with the DC voltage stabilizing unit 22 to act as the DC source. The power supply 2 in this disclosure can perform (1) the electrical energy management upon the variable speed blowing devices, the regional power demand control upon the corresponding internal electrical energy management system 3, (2) the optimal calculation of the data of the environmental detection information 4 accessed by the control unit so as to obtain the modified power consumption preset values of the respective blowing devices, and (3) the control of having the DC voltage regulator unit 26 of the power supply 2 to output the DC terminal voltages to the respective frequency-varying units of the corresponding variable speed blowing devices so as to control the operation of the motors. Namely, the power supply 2 with the variable speed blowing devices can use the rectification unit 21 and the DC voltage stabilizing unit 22 as the power sources. The control unit 23 utilizes the input information of the input unit 24 and the electrical energy measuring information of the at least one DC voltage regulator unit 26, and further introduces the priority method to adjust the output terminal voltages of the at least one DC voltage regulator unit 26 for controlling the operation of the variable speed blowing devices. The control unit 23 can also use the communication unit 25 to output the electrical energy measuring information to the far-end electrical energy management system, and also apply the electrical energy-reserved optimal computation method of the system to obtain the optimal power consumption preset values of the corresponding blowing devices. The optimal power consumption preset values are then forwarded back to the control units 23 of the power supply so as to adjust the terminal voltages outputted by the at least one DC voltage regulator unit 26, such that the speeds of the corresponding blowing devices can be adjusted, and the optimal regional electrical energy-reserved demand control can be achieved. Hence, the power supply in this disclosure is capable of adjusting the terminal voltages and the power consumption measuring.

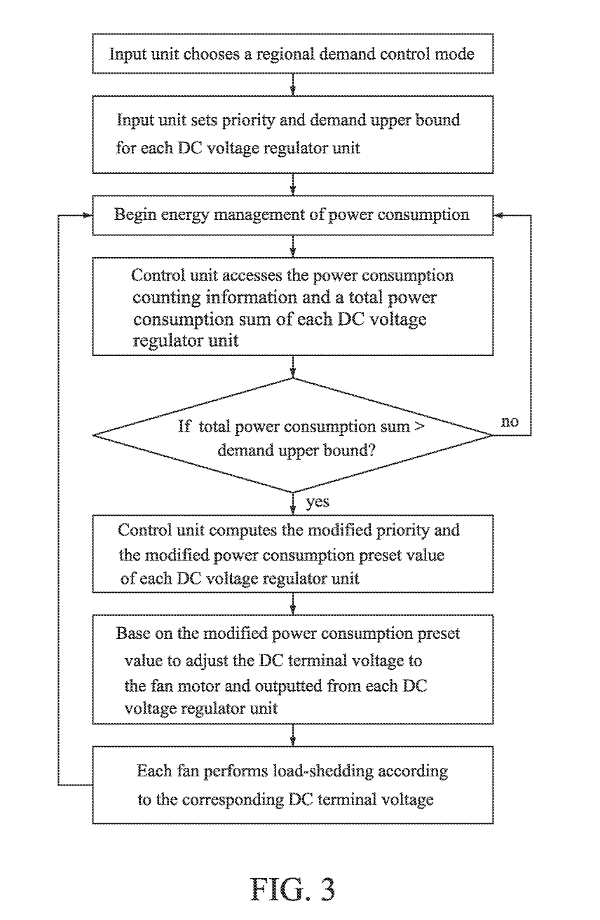

Referring now to FIG. 3, a flowchart of a regional power demand control of the electrical energy management method of this disclosure is shown. In FIG. 3, the input unit 23 at a regional demand control mode is to set the priorities a1, a2, . . . , an and the demand upper bound Pupp of the at least one DC voltage regulator unit 26. When the electrical energy management is carried out, the control unit 23 would access the power consumption measuring information P1, P2, . . . , Pn and the total power consumption sum

Psum of the at least one DC voltage regulator unit. In one embodiment of this disclosure, the control unit 23 would apply the following equations to compute the modified priorities b1, b2, . . . , bn and the sum bsum.

$$b 1 = a 1 \times ( \frac{P 1}{Psum} ) , b 2 = a 2 \times ( \frac{P 2}{Psum} ) , … , bn = an \times ( \frac{Pn}{Psum} )$$

In the case that the total power consumption sum Psum is larger than the preset demand upper bound, the control unit 23 would apply the following equations to compute the modified power consumption preset values P1′ to Pn′ of the at least one DC voltage regulator unit.

$$P {1}^{′} = P 1 - ( \frac{b 1}{bsum} ) \times ( Psum - Pupp ) , … , \\ {Pn}^{′} = Pn - ( \frac{bn}{bsum} ) \times ( Psum - Pupp )$$

The modified power consumption preset values are then fed back to the control unit 23 of the power supply 1 to adjust the terminal voltages outputted from the at least one DC voltage regulator unit 26 so as to make individual variable speed blowing devices achieve the electrical energy-reserved management goal of the regional demand control by load shedding according to the aforesaid priorities.

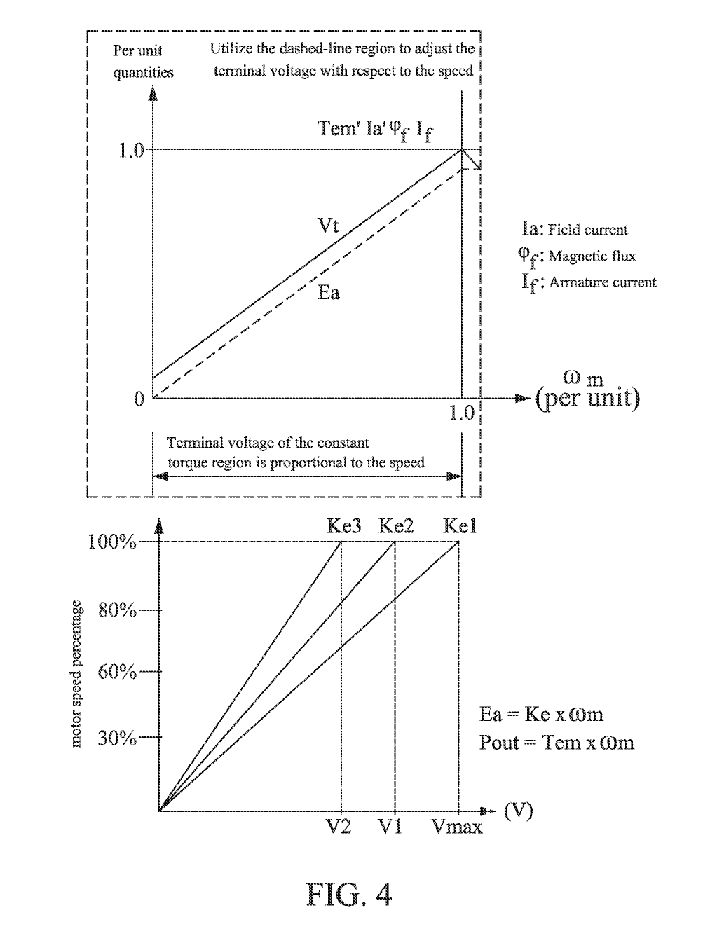

Referring now to FIG. 4, the operational characteristics between the terminal voltages of blowing devices and the corresponding speeds of the blowing devices in this disclosure is shown, which is to elucidate the logics of the electrical energy management applied in this disclosure. In FIG. 4, the X axis stands for a DC terminal voltage of the blowing device, while the Y axis stands for the motor speed percentage. The power consumption of motor and the torque speed can be derived according to the following equations.

Ea=Ke×ωm

Pout=Tem×ωm

in which

Ea: terminal voltage, induced electromotive force

Ke: motor constant

ωm: motor speed

Pout: power consumption of motor

Tem: torque

In FIG. 4, in the case that the permanent magnet variable speed motor is under a specific torque (Tem), the corresponding speed (ωm) is nearly proportional to the terminal voltage (Vt); i.e. a linear relationship. In the figure, Ia stands for the field current, φ_{f} stands for the magnetic flux, and I_{f} stands for the armature current. Hence, if a specific speed region is assigned to be the domain of control, the power consumption of the motor can be adjusted to meet the terminal voltage (or, the programmable terminal voltage) so as to manage the motor. The control unit 23 has the power consumption preset value to be transformed into the DC voltage for the motor on the blowing device outputted from the at least one DC voltage regulator unit. The at least one DC voltage regulator unit outputs the DC voltage to the drive unit of the variable speed blowing device so as to make the blowing device achieve the operation of the preset power demand control.

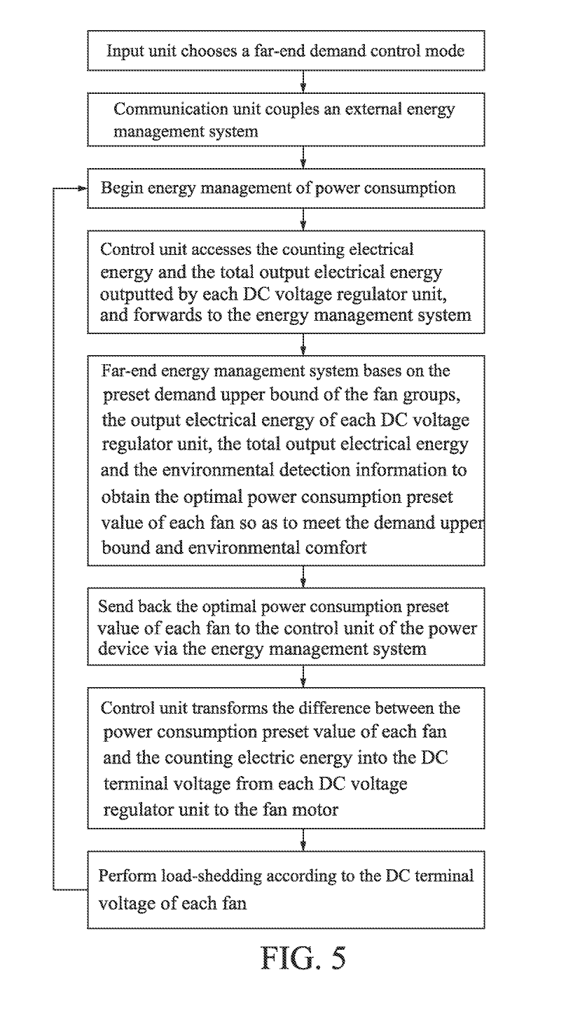

Referring now to FIG. 5, a flowchart of an embodiment of a far-end demand control of the electrical energy management method in this disclosure is shown. In this embodiment, the control is performed as the far-end demand control externally in the electrical energy management system. While in performing the electrical energy management, the control unit 23 accesses the measuring electrical energy and the total output electrical energy outputted by the at least one DC voltage regulator unit, and the aforesaid two accessed information are immediately forwarded to the far-end electrical energy management system. The far-end electrical energy management system bases on the preset demand upper bound of the blowing devices, the output electrical energy of the at least one DC voltage regulator unit, the total output electrical energy thereof and the environmental detection information to obtain the optimal modified power consumption preset values after an optimal computation. Then, the far-end electrical energy management system sends the optimal modified power consumption preset values back to the control unit 23, and the control unit 23 transforms the modified power consumption preset values into the DC voltages outputted to the variable speed blowing devices from the at least one DC voltage regulator unit, referred to FIG. 4. In addition, the at least one DC voltage regulator unit is controlled to output the DC voltage to the drive unit of the variable speed blowing device, such that the controlled operation of the variable speed blowing device can be performed in accordance with the optimal computation of the electrical energy management system.

In this disclosure, the rectification unit can be an AC/DC rectifier with the power factor correction function, and the DC voltage stabilizing unit can be a DC/DC transformer.

In this disclosure, the input unit can be a manual-operated interface, and the control unit can be a microprocessor. Further, the input unit can be one of a keyboard, a mouse and a touch screen.

In this disclosure, the communication unit can be a cable or wireless communication interface of a standard communication protocol. In particular, the communication unit can be one of an RS232, an RS485, an Ethernet, a ZigBee and a Wi-Fi.

In this disclosure, the DC voltage regulator unit can be a DC/DC transformer having an electrical energy measuring circuit module.

In this disclosure, the priorities a1, a2, . . . , an of the DC voltage regulator unit are all positive integrals, and the modified priorities b1, b2, . . . , bn are all positive reals.

In this disclosure, the optimal computation can be one of a gradient method, a simulated annealing method, a genetic algorithm, and a fuzzy algorithm.

By providing the power supply of the variable speed blowing devices and the accompanying electrical energy management method thereof in accordance with this disclosure, following limitations of the conventional variable speed blowing devices can be removed.

(1) The power supply for variable speed blowing devices is compatible with both the AC source and the DC source, and is able to adjust dynamically the terminal voltages.

(2) The inclusion of the input framework for integrating the AC/DC sources into the power supply of this disclosure provides a new era for the renewable electrical energy sources, and greatly enhances the efficiency of the renewable power sources.

(3) This disclosure uses the adjusted terminal voltages and the electrical energy measuring information to pair the characteristics of the variable speed blowing devices, to define the linear relationship between the motor speed and the terminal voltage, and further to help achieve the blowing devices demand control by adjusting the blowing device power consumption.

(4) The power supply of this disclosure includes plural electrical energy measuring functions, and thereby can reduce the cost by reducing the number of the communicative AC meters.

(5) In this disclosure, for the AC/DC transformation and the power factor correction are handled in the power supply, the cost of the blowing device can be reduced, the possibility of modularization can be increased, and the speed command of the blowing device can be realized by adjusting the terminal voltage of the power source so as to further reduce the cost of the blowing device by waiving the expense in communication.

(6) The electrical energy management method provided to the power supply of this disclosure can achieve the maximum demand control. For the demand control on the variable speed blowing devices is performed at the power supply (i.e. the power supply) in accordance with this disclosure, the complexity of the conventional electrical energy management in having the communication interfaces to couple the blowing devices in demand control and the accompanying cost in power meters, communication units, communicative platforms and demand controllers can be substantially reduced. Also, the scheduling control of the electrical energy management provided in this disclosure can be more flexible than that for the conventional blowing devices, such that the regional over-heat or super-cool situations can be improved.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A power supply for variable speed blowing devices, comprising:
a rectification unit with a power factor correction function, electrically connected with a foreign AC power of a municipal power network;
a DC (direct current) voltage stabilizing unit, electrically connected with the rectification unit and a foreign renewable energy source;
a control unit, signally connected with the DC voltage stabilizing unit;
an input unit, signally connected with the control unit;
at least one DC voltage regulator unit with an electrical energy measuring function, electrically connected with the DC voltage stabilizing unit and signally connected with the control unit; and
at least one variable speed blowing device, paired to a respective one of the at least one DC voltage regulator unit and thus to be energized by the corresponding DC voltage regulator unit;
wherein the rectification unit is able to receive an alternative current (AC) of the AC power of the municipal power network and performs a power factor correction thereupon so as to form a correspondent DC source coupled with the DC voltage stabilizing unit;
wherein the DC voltage stabilizing unit is able to receive one of the DC source and the renewable electrical energy source to perform voltage transformation into a DC source;
wherein the rectification unit and the DC voltage stabilizing unit are both to act as the power sources, the control unit utilizes input information of the input unit and electrical energy measuring information of the at least one DC voltage regulator unit, and the control unit further applies a priority method to adjust terminal voltages output from the at least one DC voltage regulator unit so as to control operation of the at least one variable speed blowing device.

2. The power supply for variable speed blowing devices according to claim 1, wherein the rectification unit is an AC/DC rectifier with the power factor correction function, and the DC voltage stabilizing unit is a DC/DC transformer.

3. The power supply for variable speed blowing devices according to claim 1, wherein the input unit is a manual-operated interface, and the control unit is a microprocessor.

4. The power supply for variable speed blowing devices according to claim 3, wherein the input unit is one of a keyboard, a mouse and a touch screen.

5. The power supply for variable speed blowing devices according to claim 1, further including a communication unit, the communication unit being one of an RS232, an RS485, an Ethernet, a ZigBee and a Wi-Fi, the control unit using the communication unit to output the electrical energy measuring information to a far-end electrical energy management system, the control unit applying an electrical energy-reserved optimal computation method of the far-end electrical energy management system to obtain optimal power consumption preset values of the corresponding blowing devices, the optimal power consumption preset values being then forwarded back to the control units of the power supply so as to adjust the terminal voltages outputted by the at least one DC voltage regulator unit, such that speeds of the corresponding blowing devices are adjusted, and an optimal regional electrical energy-reserved demand control is achieved.

6. The power supply for variable speed blowing devices according to claim 1, wherein the DC voltage regulator unit is a DC/DC transformer having an electrical energy measuring circuit module.

7. An electrical energy management method for a power supply for variable speed blowing devices, comprising the steps of:
a step of a control unit accessing a preset demand's upper bound of an input unit, priority information and electrical energy measuring information of at least one DC voltage regulator unit;
a step of the control unit introducing a modified priority computation method to calculate a modified power consumption preset value of the at least one DC voltage regulator unit;
a step of the computation method further including a step of the input unit giving priorities a1, a2, . . . , an for the at least one DC voltage regulator unit and the power demand's upper bound Pupp, and a step of the control unit accessing power consumption measuring information P1, P2, . . . , Pn and a total power consumption Psum (Psum=P1+P2+ . . . +Pn) of the at least one DC voltage regulator unit;
a step of the control unit calculating modified priorities b1, b2, . . . , bn and a sum of the modified priorities bsum (bsum=b1+b2+. . . +bn);
$$b 1 = a 1 \times ( \frac{P 1}{Psum} ) , b 2 = a 2 \times ( \frac{P 2}{Psum} ) , … , bn = an \times ( \frac{Pn}{Psum} )$$
a step of the control unit calculating modified power consumption preset values P1′ to Pn′ of the at least one DC voltage regulator unit; and
$$P {1}^{′} = P 1 - ( \frac{b 1}{bsum} ) \times ( Psum - Pupp ) , … , \\ {Pn}^{′} = Pn - ( \frac{bn}{bsum} ) \times ( Psum - Pupp )$$
a step of sending the modified power consumption preset values back to the control unit of the power supply, the control unit judging a relation of a speed and a power consumption to transform the power consumption preset values into corresponding DC terminal voltages between the at least one DC voltage regulator unit and a motor of the respective blowing device, the at least one DC voltage regulator unit being also controlled to output the DC terminal voltages to corresponding drive unit of the respective variable speed blowing device so as to adjust a speed of the corresponding motor, the variable speed blowing device being operated to meet a power demand control.

8. The electrical energy management method according to claim 7, wherein the priorities a1, a2, . . . , an of the at least one DC voltage regulator unit are all positive integrals, and the modified priorities b1, b2, . . . , bn are all positive reals.

9. The electrical energy management method according to claim 8, wherein the rectification unit is an AC/DC rectifier with a power factor correction function, and the DC voltage stabilizing unit is a DC/DC transformer.

10. The electrical energy management method according to claim 8, wherein the input unit is a manual-operated interface, the control unit is a microprocessor, and the communication unit is a communication interface of a standard communication protocol.

11. The electrical energy management method according to claim 10, wherein the input unit is one of a keyboard, a mouse, and a touch screen.

12. The electrical energy management method according to claim 10, wherein the communication unit is one of an RS232, an RS485, an Ethernet, a ZigBee and a Wi-Fi.

13. The electrical energy management method according to claim 8, wherein the DC voltage regulator unit is a DC/DC transformer having an electrical energy measuring circuit module.

14. An electrical energy management method for a power supply for variable speed blowing devices, comprising the steps of:
a step of a control unit accessing a measuring electrical energy and a total output electrical energy outputted by at least one DC voltage regulator unit, the measuring electrical energy and the total output electrical energy being immediately forwarded to a far-end electrical energy management system via a communication unit, and the control unit then receiving optimal modified power consumption preset values after an optimal computation from the far-end electrical energy management system; and
a step of the control unit judging a relation of a speed and a power consumption to transform the power consumption preset values into corresponding DC terminal voltages between the at least one DC voltage regulator unit and the corresponding motors of the respective blowing devices, the at least one DC voltage regulator unit is also controlled to output the DC terminal voltages to the corresponding drive units of the respective variable speed blowing devices so as to adjust speeds of the corresponding motors to meet a control of the optimal computation for the electrical energy management system.

15. The electrical energy management method according to claim 14, wherein the rectification unit is an AC/DC rectifier with a power factor correction function, and the DC voltage stabilizing unit is a DC/DC transformer.

16. The electrical energy management method according to claim 14, wherein the input unit is a manual-operated interface, the control unit is a microprocessor, and the communication unit is a cable or wireless communication interface of a standard communication protocol.

17. The electrical energy management method according to claim 16, wherein the input unit is one of a keyboard, a mouse, and a touch screen.

18. The electrical energy management method according to claim 16, wherein the communication unit is one of an RS232, an RS485, an Ethernet, a ZigBee and a Wi-Fi.

19. The electrical energy management method according to claim 14, wherein the DC voltage regulator unit is a DC/DC transformer having an electrical energy measuring circuit module.

20. The electrical energy management method according to claim 14, wherein the optimal computation is one of a gradient method, a simulated annealing method, a genetic algorithm, and a fuzzy algorithm.
